(19) United States
(12) Patent Application Publication
(10) Pub. No.: US 2009/0171797 A1
(43) Pub. Date: Jul. 2, 2009

(54) Positionally Trackable Payment Device

(75) Inventor: Frederick F. Branca, JR., Patterson, NY (US)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 12/341,507

(22) Filed: Dec. 22, 2008

Related U.S. Application Data
(60) Provisional application No. 61/017,354, filed on Dec. 28, 2007.

(51) Int. Cl. G06Q 20/00; G01C 21/00; G06F 19/00; G06K 19/067

(52) U.S. Cl. 705/17; 701/301; 701/213; 235/380; 235/491

(57) ABSTRACT

A payment device includes a positioning module for determining a location of the payment device. The positioning module has a receiver for receiving a signal from a navigational system. A first antenna is operably connected to the positioning module. A transmitting module is operably connected to the positioning module. The transmitting module emits a location signal corresponding to the location of the payment device as determined by the positioning module. An account information element is interrogatable by a point of sale device for permitting the completion of a commercial transaction.

This application claims the benefit of priority to U.S. Provisional Application 61/017,354 filed on Dec. 28, 2007 which is incorporated by reference herein in its entirety.

### FIELD OF THE INVENTION

The present invention relates to a payment device and, more particularly, to a payment device having a positional location device for determining and tracking the location of the payment device.

### BACKGROUND OF THE INVENTION

Payment devices such as credit cards, debit cards, prepaid cards, gift cards, RFID (radio frequency identification)-enabled fobs, and the like allow a user to conduct a commercial transaction over existing payment networks such as the MasterCard® network. Such devices may be issued by an issuer, e.g. a financial institution, and used by a user. If any particular payment device is lost or stolen, it may take some time before the user realizes whether they have simply misplaced the device or if it has been actually lost or stolen. Accordingly, it is typical for some time to elapse between when a user loses a card and when they notify the issuer to have the card deactivated. During this time period the card may remain active and subject to fraudulent transactions. It is also typical that under one account multiple devices may be issued, such as in a business setting or in a family setting. It may be desirable for the entity ultimately responsible for the payment of the bills to determine where the card is at any given time.

It is known to locate a person or object using a global navigation satellite system such as the NAVSTAR global positioning system or “GPS”. This system includes a group of earth-orbiting satellites that emit signals which may be picked up by a GPS receiver. A GPS receiver typically locates four or more of these satellites in order to determine the location of the receiver on the earth. GPS units having a receiver are well known and can include hand-held units which provide individuals their location, and devices used in aviation and military applications in order to track location and speed of an object. GPS systems have also been used in tracking systems. The GPS receiver and related components determine the location of the receiver and a transmitting device may then transmit that location via a terrestrial communication system.

Heretofore, the ability to track the location of a payment device has not been achieved. Accordingly, it would be desirable to provide a payment device that can be located and tracked.

### SUMMARY OF THE INVENTION

The present invention provides a payment device including a positioning module for determining a location of the payment device. The positioning module has a receiver for receiving a signal from a navigational system. A first antenna is operably connected to the positioning module. A transmitting module is operably connected to the positioning module. The transmitting module emits a location signal corresponding to the location of the payment device as determined by the positioning module. An account information element is interrogatable by a point of sale device for permitting the completion of a commercial transaction.

The present invention further provides a positionally trackable payment device includes a positioning module for determining a location of the payment device. The positioning module has a GPS receiver for receiving a signal from a satellite navigational system. A transmitting module is operably connected to the positioning module. The transmitting module emits a location signal corresponding to the location of the payment device as determined by the positioning module. The transmitting module is adapted to communicate with a wireless communication network. The location signal is transmitted in response to a signal generated remote from the payment device. An account information element is interrogatable by a point of sale device for permitting the completion of a commercial transaction.

The present invention also provides a system for tracking a payment device including a payment device including a positioning module for determining a location of the device. A transmitting module is in operative communication with the positioning module. The transmitting module transmits location information relating to the physical location of the payment device. The payment device also includes an account transaction element. A tracking terminal is in operative communication with the payment device. The tracking terminal receives location information transmitted from the transmitting module. The tracking terminal is remotely accessible to permit the position information to be accessed remotely.

The present invention still further provides a method of locating the position of a payment device including:

providing a payment device having a positioning module for determining a location of the device, and a transmitting module in operative communication with the positioning module for transmitting the payment device's location, and having an account transaction element; and

selectively transmitting the payment device's location in response to an event.

### BRIEF DESCRIPTION OF THE DRAWINGS

FIG. 1 is a schematic representation of an embodiment of a payment device.

FIG. 2 is a schematic representation of a front face of the payment device of FIG. 1.

FIG. 3 is a schematic representation of the tracking system of the present invention.

FIG. 4 is a schematic representation of an alternative embodiment of a payment device of the present invention.

### DETAILED DESCRIPTION OF THE PREFERRED EMBODIMENTS

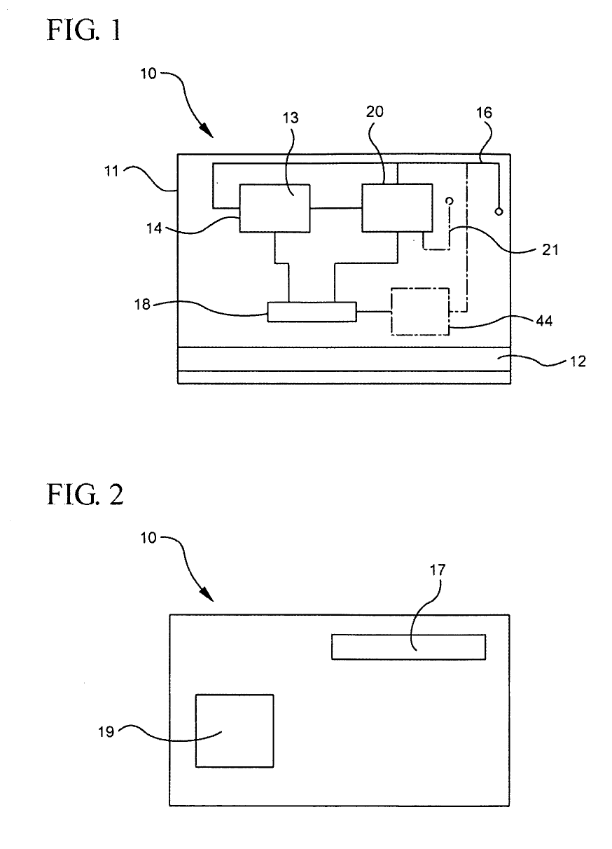

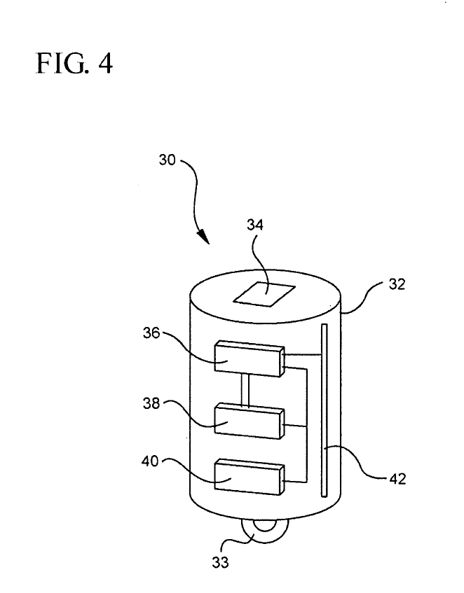

With reference to FIG. 1, the present invention includes a payment device 10 which may be used to perform a commercial transaction, such as payment of goods or services. The payment device may be in the form of a credit card, debit card, phone card, gas card, prepaid card, and the like. The payment device may also be in the form of a fob as shown and described below with respect to FIG. 4.

The payment device 10 may include housing 11 having a generally planar configuration. The configuration may be similar to a credit card. A credit card typically has the dimensions of approximately 54 mm by 86 mm. The housing 11 may include an account information element 12 such as a magnetic strip of material, RFID element, or microchip. This element 12 may have a memory element which stores the account information associated with the user's account. The account information element 12 may be interrogated by a point of sale device in order to permit the completion of a financial transaction in a manner well known in the art.

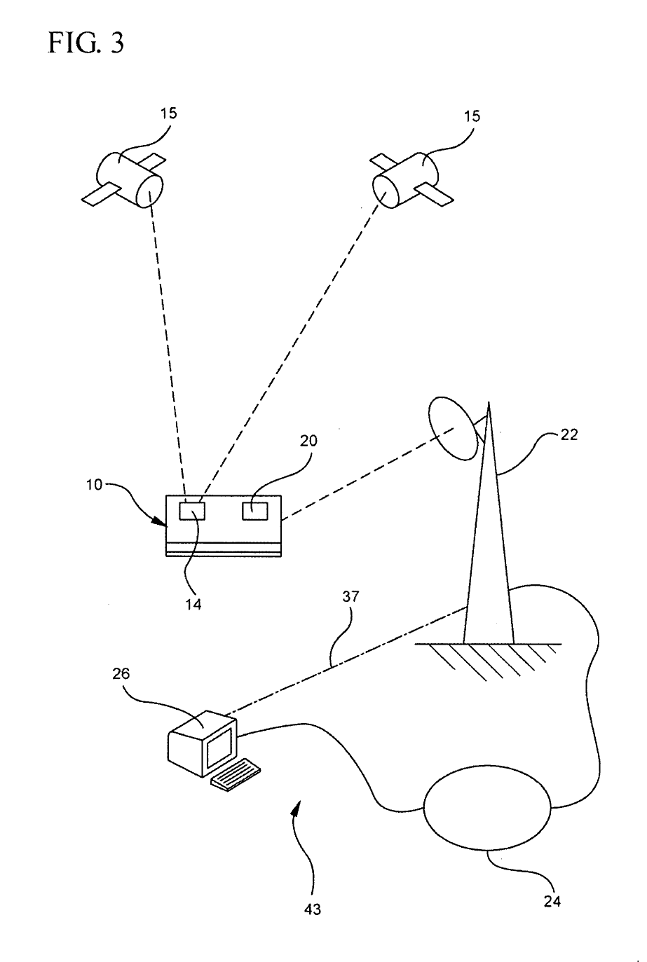

With additional reference to FIG. 3, the payment device 10 may further include a positioning module 14, such that the position of the payment device may be determined from a remote location. The positioning module 14 may preferably include a GPS receiver 13 which is capable of receiving signals from a navigational satellite system 15 such as GPS. The positioning module 14 may be a type having a very small foot print allowing it to be embedded on payment devices such as card-based devices, e.g., credit cards. One such module may be a GPS receiver based on the SiRFstarIII chip set which is marketed by SiRF Technology Holdings. Other ultra small form factor GPS receivers could be used such as the MN1010 marketed by Micro Modular Technologies, of Singapore. The receiver may further include or be operably connected to an antenna 16 disposed on the housing 11 of payment device card, and tuned to frequencies transmitted by the satellites. The receiver 13 may further include processors, and a highly-stable clock, such as a crystal oscillator.

With reference to FIGS. 1 and 2, the positioning module 14 may be operably connected to power source 18. The power source 18 may be in the form of a battery such as a rechargeable battery and/or a solar panel 17. Solar panel 17 may supply power to operate the various components and may be operably connected to the battery to provide a charge. The battery may supply power even when a light source is not available. With the positioning module 14, antenna 16 and power source 18, the payment device 10 has a capability of determining its location essentially anywhere on earth. In one embodiment, the device may also include a display screen 19 which may indicate the location of the card to a user or other indicia. Appropriate controls could be disposed on the payment device 10 in a manner known in the art.

The payment device 10 of the present invention may further include a transmitting module 20 disposed thereon. The transmitting module 20 may be operably connected to the positioning module 14 in such a manner that the location information obtained by the positioning module may be wirelessly transmitted from the payment device. The transmitting module 20 may be operably connected to the antenna 16 in order to permit signals generated from the transmitting module to be radiated from the payment device. Alternatively, a separate dedicated transmission antenna 21 may be used.

Payment device 10 transmits signals which include information relating to the position of the payment device and the identification information which identifies the specific device. The transmitted signals may be picked up by a terrestrial or spaced-based network. For example, the transmitting module 20 may be configured to transmit over a wireless network 22 (FIG. 2). The wireless network 22 may be a cellular wireless phone network such as GSM or CDMA network, or over other networks. On a GSM network the information could be sent under the short message service, SMS. These examples are not intended to be limiting, for it is within the contemplation of the present invention that any communication system or network could be employed to carry the position information. By transmitting the information, the location information may be remotely accessed in real time. The transmitting module may include the components known in the art to initiate a transmission over a wireless network and transmit information over that network.

In order to permit location tracking of the payment device in real time, the transmitted location information may be sent over the wireless network 22 to a tracking terminal 43. The tracking terminal may include the payment device issuer's computer system or network 24. The payment device issuer may include, for example, a bank, other financial institution or retailer. Such location information may be sent in response to an event. For example, the event may be use of the payment device 10. Therefore each time the payment device is used in a commercial transaction, such as when the device is interrogated, the location information may be transmitted. Alternatively, the event may be the passage of time wherein the location information is transmitted at predetermined time intervals. In a further alternative embodiment, the event may be a predetermined change in location. Therefore, when the payment device 10 is brought to a location it would transmit a signal including the location information and it would not transmit again until the location is changed by a predetermined amount. The location information transmitted by the payment device 10 may be stored along with other information regarding the account corresponding to the payment device on the issuer's computer system 24.

In one embodiment, the location of the payment device 10 may be obtained by the owner or user of the payment device by communicating with the payment device issuer's website using an access device 26 which may be in the form of a PC or other internet connectable device. The user may obtain access to their account, and once the particular payment device is accessed, they may have the option to track the location of the payment device. Alternatively, a user may be able to call into the issuer over the phone and obtain location information of the payment device 10. In one embodiment, the issuer may receive location information for the payment device when the user of the device requests tracking information. Accordingly, the transmission of a signal including location information may be initiated by a signal having a source beyond the payment device. Such a request may enable the computing systems software to start saving location information for the device at issue. Alternatively, the user's request may initiate a signal to which the payment device responds by transmitting location information. Therefore, the location of the payment device need not be tracked continuously, but only when the location information is desired.

In a further alternative embodiment, the user may be able to receive communications 37 including location information directly from the wireless system or network 22 without going through the issuer's computer system 24. In this embodiment, the payment device may be able to receive and send messages over the communications network 22. A user may have the ability to access the location information transmitted by the payment device on a home PC, via a land line phone, a cell phone or personal digital assistant, or other communication device which in this embodiment form the tracking terminal. The communication with the payment device may be achieved in a manner similar to communication over a wireless cellular network. The payment device may include a receiving device 44 (FIG. 1), such as that found on a cell phone or pager in order to allow remote communication, in addition to the transmitting module 20. The receiving device 44 may be operably connected to the antennae 16 or have its own antennae. Upon receiving a signal, the receiving device 44 in conjunction with the transmitting module 20 establish communication with the user and provide the location information.

Upon communication connection to the payment device 10 either through an issuer's computer system 24 or directly, the payment device may transmit a message including the location information which provides the physical location of the payment device. The transmission of this information may first require the sending of a password or code. The payment device's location may then be determined and the payment device 10 retrieved.

In addition, once the location of the payment device 10 is determined, the user can choose to have the device deactivated if it appears that the device is no longer in the control of the user. Deactivation may be achieved by contacting the issuer of the payment device who in turn could deactivate the device in a manner well known in the art. Alternatively, a signal could be sent directly to the payment device over the wireless network which would be interpreted by hardware and/or software on the payment device to cause the account information element 12 to become inoperative.

GPS tracking software to track the location of the payment device may be installed into a home PC, cell phone or other type of communication device. Such a device may also be disposed in an automobile. The whereabouts of the payment device 10 can then be tracked by the user at will in real time by way of the software. Due to the flexibility and ease of use, the user may have immediate access and flexibility in tracking/tracing the whereabouts of their payment device.

It is within the contemplation of the present invention that the payment device may include configurations in addition to a planar card-type form. For example, in an alternative embodiment shown in FIG. 4, the payment device 30 may include a housing 32 which may be in a wide variety of shapes and sizes. The payment device 30 may operate in the same manner as the payment device 10 described above and include the same or similar components. The housing 32 may be a fob-type housing including an element 33 which permits it to be attached to another element such as a key ring or lanyard. Alternatively, the housing 32 may be formed without such an element. Housing 32 may include an account information element 34 such as an RFID module which is capable of transmitting account identification information when interrogated by a point of sale device in a manner known in the art. The housing 32 may alternatively include a magnetic strip, bar code, or other device for storing account identification information.

The housing 32 may further include a positioning module 36 and transmitting module 38. Both modules may be operably connected to each other and to a power source 40. An antenna 42 may be enclosed in the housing 32 or extending therefrom for receiving positioning signals and transmitting position information signals. It is within the contemplation of the present invention that the positioning module may be operably connected to a first antenna and the transmitting module may be operably connected to a second antenna (not shown). The payment device 30 is capable of determining its location through use of the GPS network and transmitting that location. Payment device may also include a receiving device (not shown) such as described above with respect to payment device 10, for receiving communications prompting transmission of location information.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A payment device comprising:
a positioning module for determining a location of the payment device, the positioning module having a receiver for receiving a signal from a navigational system;
a first antenna operably connected to the positioning module; and
a transmitting module operably connected to the positioning module, the transmitting module emitting a location signal corresponding to the location of the payment device as determined by the positioning module; and
an account information element interrogatable by a point of sale device for permitting the completion of a commercial transaction.

2. The device of claim 1 further including a housing, and the positioning module, the first antenna and the transmitting module are supported on the housing.

3. The device of claim 2, wherein the housing includes a planar member.

4. The payment device of claim 3, wherein the housing generally has the configuration of a credit card.

5. The device of claim 2, wherein the housing includes an attachment element for securing the housing to a structure.

6. The device of claim 1, wherein the transmitting module is selectively in operative communication with a wireless network.

7. The device of claim 1, wherein the account information element includes a strip of magnetic material located on the surface of the housing.

8. The device of claim 1, wherein the transmitting module transmits the location signal in response to a signal emanating from beyond the payment device.

9. The device of claim 1, wherein the transmitting module transmits the location signal in response to interrogation of the account information element by the point of sale device.

10. The device of claim 1, wherein the transmitting module transmits the location signal at predetermined changes in time or location.

11. The device of claim 1, wherein the positioning module includes a GPS receiver.

12. A positionally trackable payment device comprising:
a positioning module for determining a location of the payment device, the positioning module having a GPS receiver for receiving a signal from a satellite based navigational system; and
a transmitting module operably connected to the positioning module, the transmitting module emitting a location signal corresponding to the location of the payment device as determined by the positioning module, the transmitting module being adapted to communicate with a wireless communication network, the location signal being transmitted in response to a signal generated remote from the payment device; and
an account information element interrogatable by a point of sale device for permitting the completion of a commercial transaction.

13. The device of claim 12, wherein the account information element includes a magnetic strip.

14. The device of claim 12, wherein the account information element includes an RFID device.

15. The device of claim 12, wherein the transmitter is responsive to a signal received over a wireless network to transmit location information.

16. The device of claim 12, wherein the account information element is selectively configurable between an operative and inoperative state.

17. The device of claim 12, wherein the account information element is configurable in response to a remote signal.

18. A system for tracking a payment device comprising:
a payment device including a positioning module for determining a location of the payment device, and a transmitting module in operative communication with the positioning module, the transmitting module transmitting location information relating to the physical location of the payment device, and an account transaction element; and
a tracking terminal in operative communication with the payment device, the tracking terminal receiving information transmitted from the transmitting module, the tracking terminal being remotely accessible to permit the position information to be accessed remotely.

19. The system of claim 18, wherein the transmitting module transmits the location information in response to a use of the account transaction element.

20. The system of claim 18, wherein the transmitting module transmits the location information at predetermined intervals.

21. The system of claim 18, wherein the transmitting module transmits the location information in response to a change in location of the payment device.

22. The system of claim 18, wherein the computing device includes a user interface, and location information of the payment device is accessible over the user interface.

23. The system of claim 18, wherein the tracking terminal includes an internet connectable device.

24. A method of locating the position of a payment device comprising:
providing a payment device having a positioning module for determining a location of the device, and a transmitting module in operative communication with the positioning module for transmitting the payment device's location, and having an account transaction element; and
selectively transmitting the payment device's location in response to an event.

25. The method of claim 24, wherein the event includes use of the payment device to perform a commercial transaction.

26. The method of claim 24, wherein the event includes receipt of a remote signal.

27. The method of claim 24, including storing the location transmitted by the payment device on a computer system.

28. The method of claim 27, including accessing the computer network and retrieving the payment device location.
